(19) United States
(12) Patent Application Publication
(10) Pub. No.: US 2026/0253767 A1
(43) Pub. Date: Aug. 27, 2026

(54) Thermally Stable Thin Film Resistor

(71) Applicant: NATIONAL SUN YAT-SEN UNIVERSITY, Kaohsiung City (TW)

(72) Inventor: Ying-Chieh Lee, Kaohsiung City (TW)

(21) Appl. No.: 19/352,696

(22) Filed: Oct. 8, 2025

(30) Foreign Application Priority Data
Feb. 21, 2025 (TW) 114106465

(51) Int. Cl. H01C 7/00

(52) U.S. Cl. CPC H01C 7/006

(57) ABSTRACT

A thermally stable thin film resistor includes a substrate, a resistance layer and a functional layer. The resistance layer is stacked on the substrate. A material of the resistance layer has a positive temperature coefficient of resistance. The functional layer is stacked on a surface of the resistance layer opposite to the substrate. A material of the functional layer has a negative temperature coefficient of resistance. A difference between absolute values of the temperature coefficient of resistance of the material of the resistance layer and the material of the functional layer is less than or equal to 500 ppm/° C. A thickness ratio of the resistance layer to the functional layer is between 1:7 and 7:1.

### CROSS REFERENCE TO RELATED APPLICATION

The application claims the benefit of Taiwan Application Serial No. 114106465, filed on Feb. 21, 2025, and the entire contents of which are incorporated herein by reference.

### BACKGROUND OF THE INVENTION

### 1. Field of the Invention

The present application relates to an electronic component and, more particularly, to a thermally stable thin film resistor with reduced temperature coefficient of resistance and stable resistance value.

### 2. Description of the Related Art

A thin film resistor refers to depositing resistance material at nanometer-level thickness on chips in thin film or semiconductor processes, and the resistance value of the thin film resistor can be precisely controlled by adjusting thickness and selecting materials. Therefore, thin film resistors are commonly applied in medical instruments, industrial computers, and automobiles and other precision instruments.

The temperature coefficient of resistance (TCR) of a conventional resistance component is the rate at which resistivity changes with temperature changes. In other words, in a working environment with temperature changes, a larger TCR of the resistance component will lead to more unstable resistance value, and when the TCR is positive, increased temperature will increase resistance value; conversely, when the TCR is negative, increased temperature will decrease resistance value. Conventional thin film resistors are usually used in precision instruments and products requiring high safety; therefore, conventional thin film resistors need to maintain stable and reliable resistance values in environments with temperature changes. However, when conventional thin film resistors are used in heating components or under extreme high/low temperature conditions, significant changes in resistance values still occur due to dramatic temperature changes, thereby affecting the quality and thermal stability of electronic components.

In view of this, it is necessary to improve the conventional thin film resistors.

### SUMMARY OF THE INVENTION

To solve the above problems, an objective of the present application is to provide a thermally stable thin film resistor that can adjust the TCR to approach zero.

It is another objective of the present application to provide a thermally stable thin film resistor that can improve the reliability and thermal stability of electronic components.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

The thermally stable thin film resistor of the present application includes a substrate, a resistance layer and a functional layer. The resistance layer is stacked on the substrate. A material of the resistance layer has a positive temperature coefficient of resistance. The functional layer is stacked on a surface of the resistance layer opposite to the substrate. A material of the functional layer has a negative temperature coefficient of resistance. A difference between absolute values of the temperature coefficient of resistance of the material of the resistance layer and the material of the functional layer is less than or equal to 500 ppm/° C. A thickness ratio of the resistance layer to the functional layer is between 1:7 and 7:1.

Therefore, the thermally stable thin film resistor of the present application, by stacking materials with different temperature coefficients of resistance (TCR) into a double-layer thin film structure and adjusting the thickness ratio of the double layers, can make the TCR of the double-layer thin film structure approach zero. The thermally stable thin film resistor of the present application can maintain stable and reliable resistance values in environments with large temperature changes, thereby improving the quality and thermal stability of electronic components.

In an example, a thickness of the resistance layer is between 30 nanometers and 210 nanometers, and a thickness of the functional layer is between 30 nanometers and 210 nanometers. Thus, the thickness ratio between the resistance layer and the functional layer can be adjusted, thereby controlling the TCR of the thin film resistor to approach zero.

In an example, the material of the resistance layer is a nickel-chromium based alloy with atomic percentages of 80% nickel and 20% chromium. The material of the functional layer is vanadium nitride. The thickness ratio of the resistance layer to the functional layer is between 2:3 and 3:2. Thus, the double-layer thin film structure of nickel-chromium based alloy and vanadium nitride can achieve the lowest TCR at a specific thickness ratio, thereby improving thermal stability of the resistor.

In an example, the thermally stable thin film resistor of the present application further includes two electrodes respectively disposed at two ends of a stacked structure of the resistance layer and the functional layer, and each electrode is electrically connected to both the resistance layer and the functional layer. Thus, when the two electrodes are respectively electrically connected to a voltage source, current can be transmitted through the resistance layer and the functional layer, thereby forming a double-layer thin film resistor structure and generating resistance characteristics.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a cross-sectional side view of a preferred embodiment of the present application.

FIG. 2 is a relationship graph between thickness ratio and TCR of the double-layer structure of the preferred embodiment of the present application.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, the preferred embodiments of the present invention will be described hereinafter in connection with the accompanying drawings. Furthermore, the elements designated by the same reference numeral in various figures will be deemed as identical, and the description thereof will be omitted.

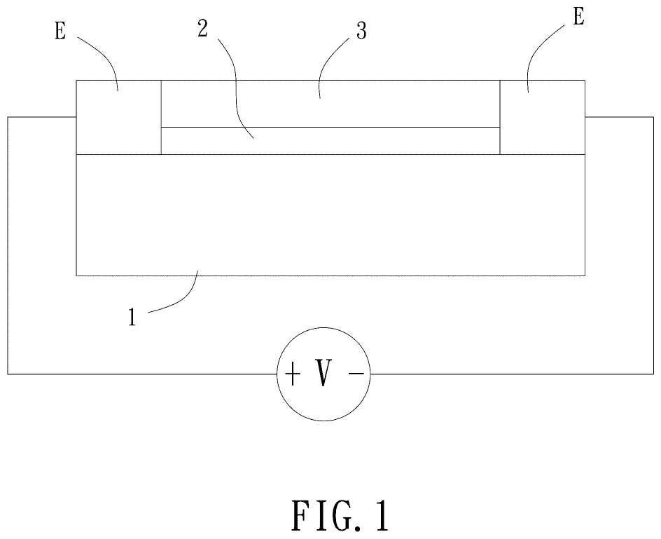

Please refer to FIG. 1, which shows a preferred embodiment of the thermally stable thin film resistor of the present application, including a substrate 1, a resistance layer 2, and a functional layer 3. The resistance layer 2 is disposed on the substrate 1, and the functional layer 3 is disposed on the resistance layer 2.

The substrate 1 is used for carrying various electronic components and circuits. The resistance component materials can be formed on the substrate 1 by sputtering, such as DC magnetron sputtering and radio-frequency magnetron sputtering, or evaporation, laser deposition and other technologies. The substrate 1 can be made of ceramic materials such as aluminum oxide or silicon carbide.

The resistance layer 2 forms a thin film and is stacked on a carrying surface of the substrate 1. The thickness of the resistance layer 2 can be 30 nanometers to 210 nanometers, preferably 40 nanometers, 60 nanometers, 70 nanometers, 80 nanometers, 100 nanometers, 120 nanometers, 140 nanometers, 150 nanometers, 160 nanometers, 180 nanometers or 200 nanometers. The material of the resistance layer 2 has a positive TCR. The material of the resistance layer 2 can be an alloy, also known as metallic compound or intermetallic compound, which is a compound formed by two or more metallic elements in fixed proportions. In this embodiment, the material of the resistance layer 2 is nickel-chromium based alloy Ni₈₀Cr₂₀, i.e., atomic percentages of nickel and chromium are 80% and 20% respectively. However, the material of the resistance layer 2 of the present application can also have other atomic percentages or include other elements, such as: nickel 50% chromium 50%, nickel-chromium-silicon compound, nickel-chromium-silicon-aluminum compound, etc. The present application is not limited to the above materials.

The functional layer 3 is stacked on another surface of the resistance layer 2 opposite to the substrate 1. The thickness of the functional layer 3 can be 30 nanometers to 210 nanometers, preferably 40 nanometers, 60 nanometers, 70 nanometers, 80 nanometers, 100 nanometers, 120 nanometers, 140 nanometers, 150 nanometers, 160 nanometers, 180 nanometers or 200 nanometers. The material of the functional layer 3 has a negative TCR. In this embodiment, the material of the functional layer 3 is vanadium nitride, which has characteristics of high strength, corrosion resistance, thermal stability, electrical and thermal conductivity. By combining the functional layer 3 with the resistance layer 2, the thin film resistor structure can be protected, and the thin film resistance characteristics can be modified.

Furthermore, the difference between an absolute value of the TCR of the material of the resistance layer 2 and an absolute value of the TCR of the material of the functional layer 3 is less than or equal to 500 ppm/° C., and the thickness ratio of the resistance layer 2 to the functional layer 3 is between 1:7 and 7:1, which can make the TCR of the thin film resistor formed by combining the resistance layer 2 and the functional layer 3 approach zero.

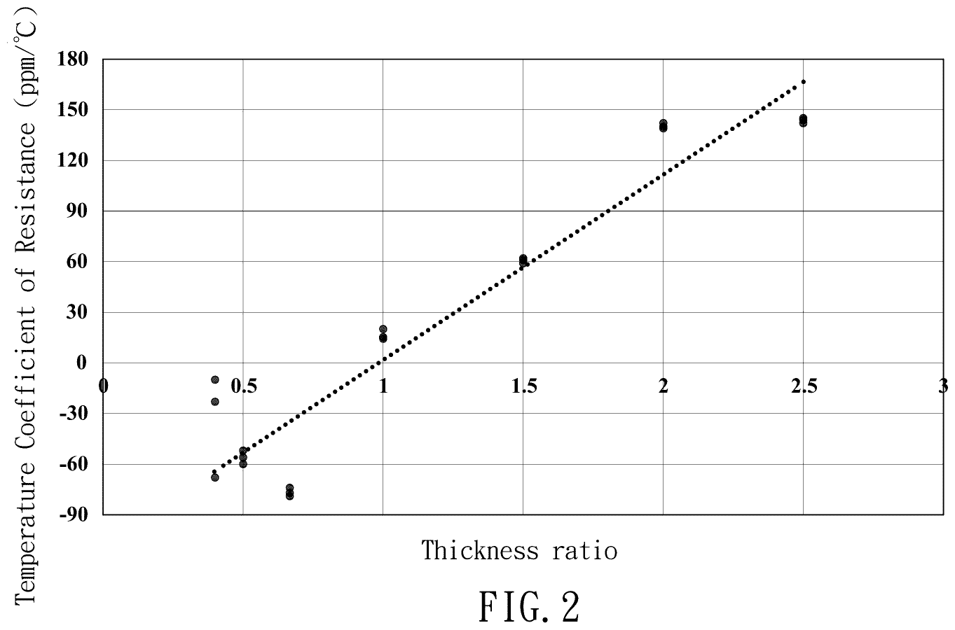

Please refer to FIG. 2 and the following Table 1, in this embodiment, the material of the resistance layer 2 is nickel-chromium based alloy Ni₈₀Cr₂₀, and the TCR of the material of the resistance layer 2 is 100±20 ppm/° C.; while the material of the functional layer 3 is vanadium nitride, and the TCR of the material of the functional layer 3 is −500±50 ppm/° C. Furthermore, the thickness ratio of the resistance layer 2 to the functional layer 3 can be 2:5, 1:2, 2:3, 1:1, 3:2, 2:1 or 5:2, and preferably 1:1, which can reduce the TCR of the thin film resistor to as low as 15.2 ppm/° C.

TABLE 1
Thin film resistance characteristics of combined nickel-
chromium based alloy Ni₈₀Cr₂₀ and vanadium nitride (VN).

| | | | |
|---|---|---|---|
| Thickness | Thickness | Thickness | |
| (Ni₈₀Cr₂₀) | (VN) | ratio | TCR |

| | | | | | | |
|---|---|---|---|---|---|---|
| 60 | nm | 150 | nm | 2:5 | −50 ± 40 | ppm/° C. |
| 70 | nm | 140 | nm | 1:2 | −55 ± 5 | ppm/° C. |
| 80 | nm | 120 | nm | 2:3 | −75 ± 5 | ppm/° C. |
| 100 | nm | 100 | nm | 1:1 | 15 ± 5 | ppm/° C. |
| 120 | nm | 80 | nm | 3:2 | 60 ± 5 | ppm/° C. |
| 140 | nm | 70 | nm | 2:1 | 140 ± 5 | ppm/° C. |
| 150 | nm | 60 | nm | 5:2 | 140 ± 5 | ppm/° C. |

The thermally stable thin film resistor of the present application can further include two electrodes E. The two electrodes E are respectively disposed at two ends of a stacked structure of the resistance layer 2 and the functional layer 3, making each electrode E electrically connected to both the resistance layer 2 and the functional layer 3. When the two electrodes E are respectively electrically connected to a voltage source V, current can be transmitted between the two electrodes E through the double-layer thin film resistor structure formed by the resistance layer 2 and the functional layer 3.

In view of the foregoing, the thermally stable thin film resistor of the present application, by stacking materials with different TCR into a double-layer thin film structure and adjusting the thickness ratio of the double layers, can make the TCR of the double-layer thin film structure approach zero. The thermally stable thin film resistor of the present application can maintain stable and reliable resistance values in environments with large temperature changes, thereby improving the quality and thermal stability of electronic components.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A thermally stable thin film resistor, comprising:
a substrate;
a resistance layer stacked on the substrate, wherein a material of the resistance layer has a positive temperature coefficient of resistance; and
a functional layer stacked on a surface of the resistance layer opposite to the substrate, wherein a material of the functional layer has a negative temperature coefficient of resistance;
wherein a difference between absolute values of the temperature coefficient of resistance of the material of the resistance layer and the material of the functional layer is less than or equal to 500 ppm/° C.; and
wherein a thickness ratio of the resistance layer to the functional layer is between 1:7 and 7:1.

2. The thermally stable thin film resistor as claimed in claim 1, wherein a thickness of the resistance layer is between 30 nanometers and 210 nanometers, and a thickness of the functional layer is between 30 nanometers and 210 nanometers.

3. The thermally stable thin film resistor as claimed in claim 1, wherein the material of the resistance layer is a nickel-chromium based alloy with atomic percentages of 80% nickel and 20% chromium, wherein the material of the functional layer is vanadium nitride, and wherein the thickness ratio of the resistance layer to the functional layer is between 2:3 and 3:2.

4. The thermally stable thin film resistor as claimed in claim 1, wherein the thermally stable thin film resistor further comprises two electrodes respectively disposed at two ends of a stacked structure of the resistance layer and the functional layer, and each electrode is electrically connected to both the resistance layer and the functional layer.
